(19) United States
(12) Patent Application Publication
(10) Pub. No.: US 2020/0387171 A1
(43) Pub. Date: Dec. 10, 2020

(54) FLYING BODY CONTROL APPARATUS, FLYING BODY CONTROL METHOD, AND FLYING BODY CONTROL PROGRAM

(71) Applicant: NEC CORPORATION, Tokyo (JP)

(72) Inventor: Tetsuo INOSHITA, Tokyo (JP)

(73) Assignee: NEC CORPORATION, Tokyo (JP)

(21) Appl. No.: 16/644,346

(22) PCT Filed: Sep. 5, 2017
(86) PCT No.: PCT/JP2017/031913

§ 371 Date: Mar. 4, 2020

(51) Int. Cl. G05D 1/06; G05D 1/00; B64D 45/08; B64C 39/02

(52) U.S. Cl. CPC G05D 1/0676; G05D 1/0094; B64C 2201/127; B64C 39/024; B64C 2201/18; B64D 45/08

(57) ABSTRACT

This invention provides a flying body that can more reliably be made to fly at a desired position. The flying body includes an image capturer that captures a periphery of the flying body. The flying body also includes a recorder that records an image captured before the flying body starts a flight. The flying body further includes a flight controller that makes the flying body fly to a designated position using the image recorded in the recorder and an image captured using the image capturer during the flight.

### TECHNICAL FIELD

The present invention relates to a flying body, a flying body control apparatus, a flying body control method, and a flying body control program.

### BACKGROUND ART

In the above technical field, patent literature 1 discloses a technique of performing automatic guidance control of a flying body to a target mark placed on the ground at the time of landing to save the technique and labor of a pilot.

### CITATION LIST

### Patent Literature

Patent literature 1: Japanese Patent Laid-Open No. 2012-71645

### SUMMARY OF THE INVENTION

### Technical Problem

In the technique described in the literature, however, depending on the flight altitude, it may be impossible to accurately visually recognize the target mark, and the flying body may be unable to implement a desired flight state.

The present invention provides a technique of solving the above-described problem.

### Solution to Problem

One example aspect of the present invention provides a flying body comprising:

an image capturer that captures a periphery of the flying body;

a recorder that records an image captured before the flying body starts a flight; and

a flight controller that makes the flying body fly to a designated position using the image recorded in the recorder and an image captured during the flight.

Another example aspect of the present invention provides a flying body control apparatus comprising:

an image receiver that receives an image acquired by capturing a periphery of a flying body;

a recorder that records an image captured before the flying body starts a flight; and

a flight controller that makes the flying body fly to a designated position using the image recorded in the recorder and an image captured during the flight.

Still other example aspect of the present invention provides a control method of a flying body, comprising:

capturing a periphery of the flying body; and

making the flying body fly to a designated position using an image captured before the flying body starts a flight and recorded in a recorder and an image captured during the flight in the capturing.

Still other example aspect of the present invention provides a flying body control program for causing a computer to execute a method, comprising:

capturing a periphery of the flying body; and

making the flying body fly to a designated position using an image captured before the flying body starts a flight and recorded in a recorder and an image captured during the flight in the capturing.

### Advantageous Effects of Invention

According to the present invention, it is possible to more reliably make a flying body fly at a desired position.

### BRIEF DESCRIPTION OF DRAWINGS

FIG. 1 is a block diagram showing the arrangement of a flying body according to the first example embodiment of the present invention;

FIG. 2A is a view for explaining the flight conditions of a flying body according to the second example embodiment of the present invention;

FIG. 2B is a view for explaining the flight conditions of the flying body according to the second example embodiment of the present invention;

FIG. 3 is a view for explaining the arrangement of the flying body according to the second example embodiment of the present invention;

FIG. 4 is a view for explaining the arrangement of the flying body according to the second example embodiment of the present invention;

FIG. 5 is a view for explaining the arrangement of the flying body according to the second example embodiment of the present invention;

FIG. 6 is a view for explaining the arrangement of the flying body according to the second example embodiment of the present invention;

FIG. 7 is a view for explaining the arrangement of the flying body according to the second example embodiment of the present invention;

FIG. 8 is a flowchart for explaining the procedure of processing of the flying body according to the second example embodiment of the present invention;

FIG. 9 is a view for explaining the arrangement of a flying body according to the third example embodiment of the present invention;

FIG. 10 is a view for explaining the arrangement of the flying body according to the third example embodiment of the present invention;

FIG. 11 is a view for explaining the arrangement of the flying body according to the third example embodiment of the present invention;

FIG. 12 is a view for explaining the arrangement of the flying body according to the third example embodiment of the present invention; and

FIG. 13 is a view for explaining the arrangement of a flying body control apparatus according to the fifth example embodiment of the present invention.

### DESCRIPTION OF EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

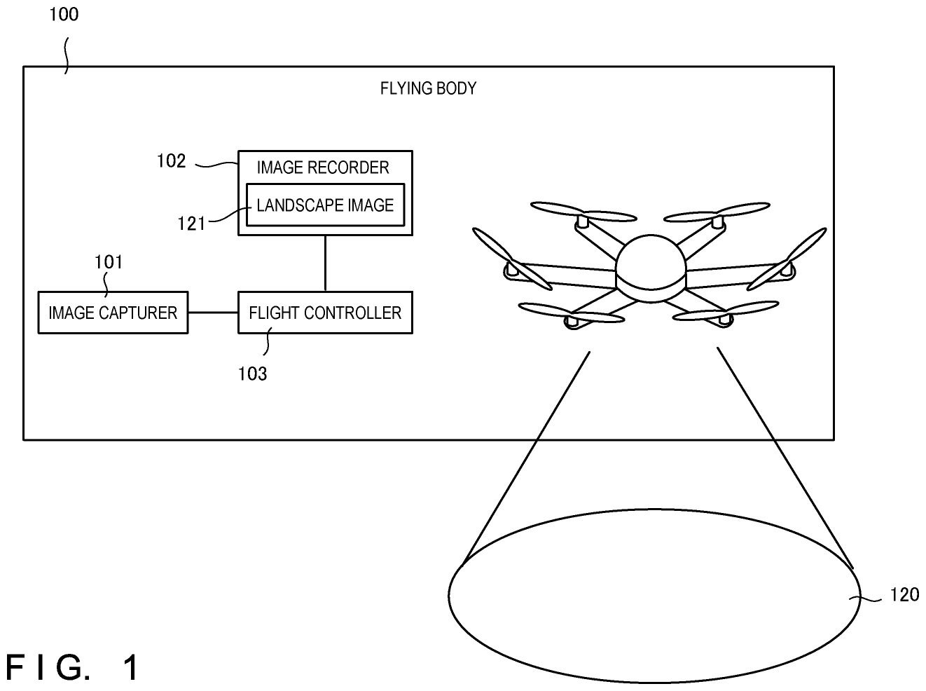

A flying body 100 as the first example embodiment of the present invention will be described with reference to FIG. 1. The flying body 100 includes an image capturer 101, a recorder 102, and a flight controller 103.

The image capturer 101 captures the periphery of the flying body 100. The image recorder 102 records a landscape image 121 captured before the flying body 100 starts a flight. The flight controller 103 makes the flying body 100 fly to a designated position using the landscape image 121 recorded in the image recorder 102 and a landscape image 120 captured during the flight.

According to the above-described arrangement, it is possible to accurately make the flying body fly at a desired position without relying on the capability of a pilot.

### Second Example Embodiment

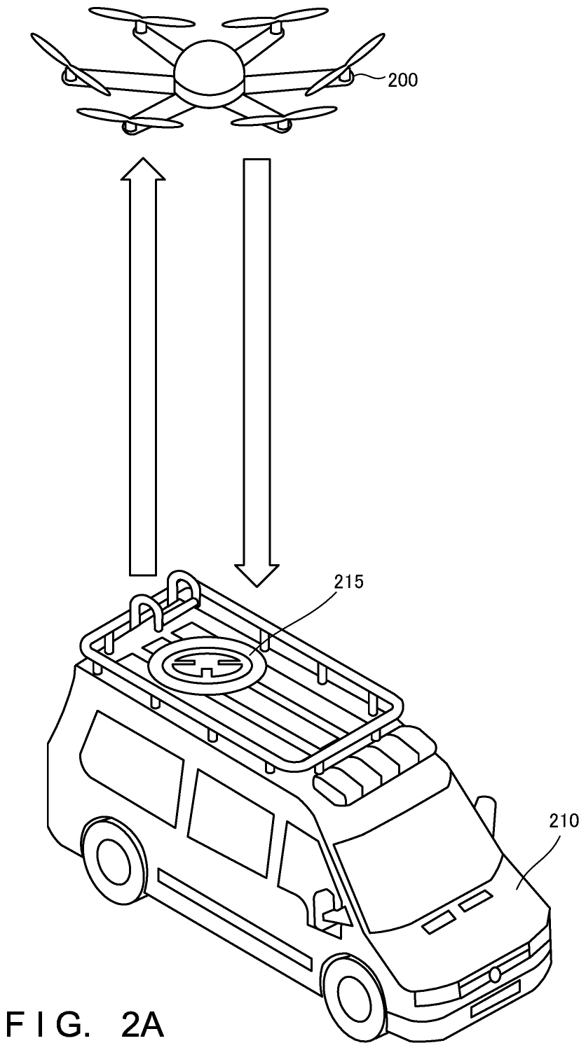

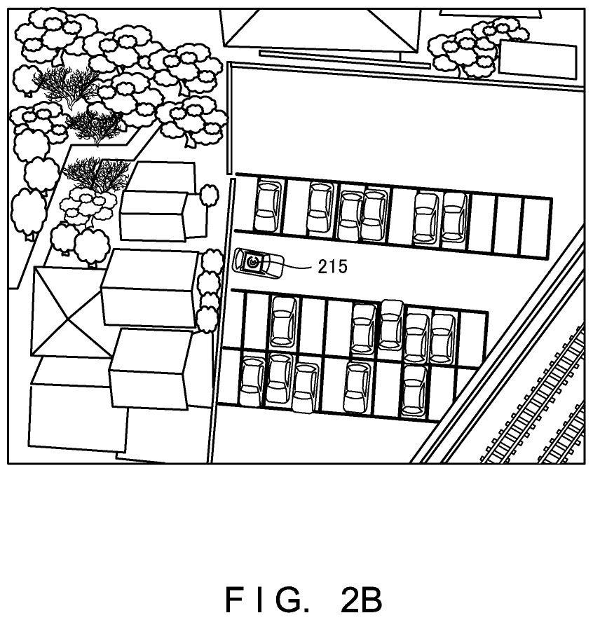

A flying body according to the second example embodiment of the present invention will be described next with reference to FIGS. 2A to 5. FIG. 2A is a view for explaining the takeoff/landing state of a flying body 200 according to this example embodiment. To dispatch the flying body 200 to a disaster area, for example, a vehicle 210 is stopped between buildings, and the flying body 200 is caused to take off/land from/to a target mark 215 provided on the roof of the vehicle.

At the time of landing, a deviation of several m occurs in control relying on a GPS (Global Positioning System), and it is therefore difficult to make the flying body land on the target mark 215. Furthermore, as shown in FIG. 2B, from a high altitude (for example, 100 m or more), the target mark 215 cannot be seen well, or a recognition error of the target mark 215 may occur because the target mark is disturbed by patterns or shapes observed on buildings on the periphery.

This example embodiment provides a technique for guiding the flying body 200 to a desired landing point (for example, on the roof of a vehicle or on a boat on the sea) without resort to the target mark.

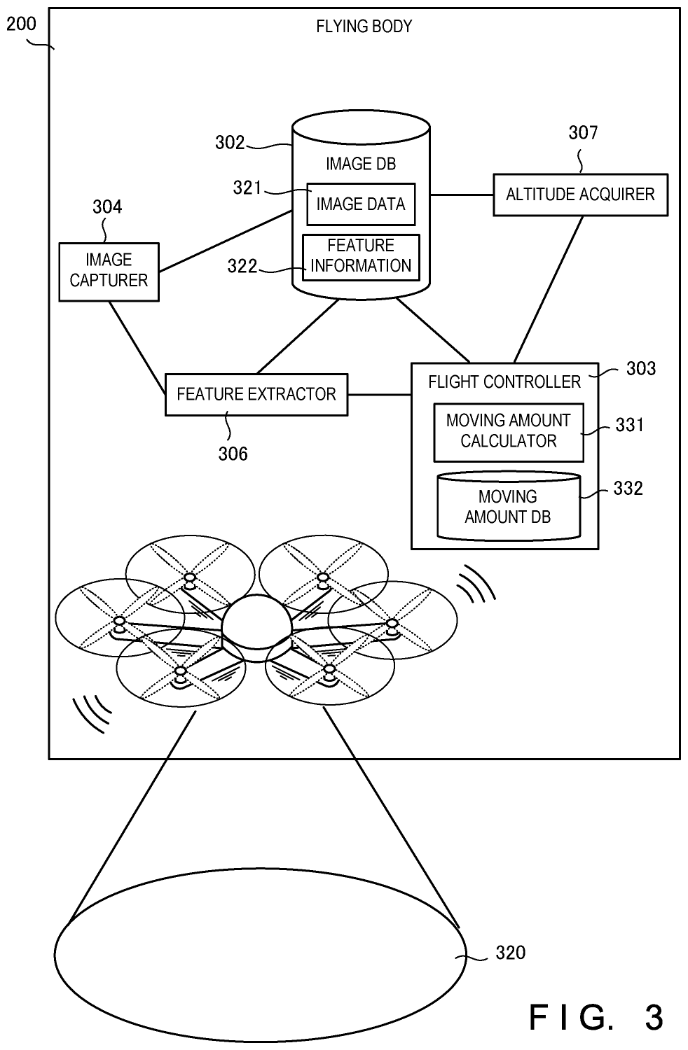

FIG. 3 is a view showing the internal arrangement of the flying body 200. The flying body 200 includes an image database 302, a flight controller 303, an image capturer 304, a feature extractor 306, and an altitude acquirer 307.

The image database 302 records image data 321 of a landscape image captured before the flying body 200 starts a flight.

The image capturer 304 captures the periphery of the flying body, and records the acquired image data in the image database 302.

The flight controller 303 controls the flight of the flying body 200 using the landscape image recorded in the image database 302 and a landscape image captured by the image capturer 304 during the flight.

The image data 321 recorded in the image database 302 may be a landscape image accessibly saved on the Internet. For example, it may be the image data of a landscape image generated by a satellite photograph or an aerial photograph (for example, image data acquired by Google earth®), or may be the image data of a landscape image captured in advance by another flying body.

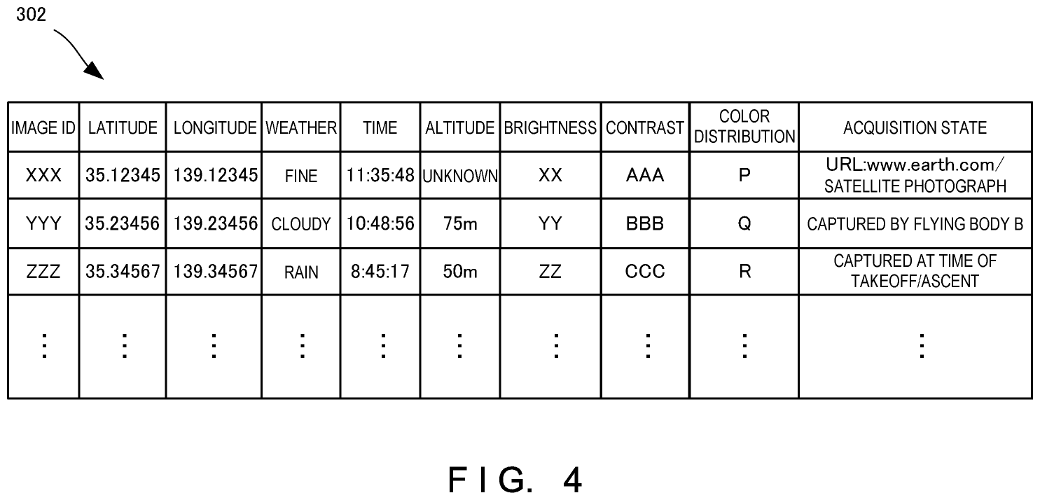

As shown in FIG. 4, each image data recorded in the image database 302 may be recorded in linkage with an image capturing date/time, a weather at the time of image capturing, an image capturing altitude, and the like. In this case, the flight controller 303 selects an image to be matched with an image captured during the flight from images recorded in the image database 302 based on at least one of a flight date/time, a weather at the time of flight, and a flight altitude.

In addition, the flight controller 303 selects an image to be matched with an image captured during the flight based on at least one of the brightness, contrast, and color distribution of each image recorded in the image database 302. The acquisition source of the image may further be recorded in the image database 302.

The feature extractor 306 extracts a feature point from the image data recorded in the image database 302. The image database 302 records feature information 322 extracted from the image data 321 in association with the image data 321. A technique of extracting feature information from an image for matching is disclosed in ORB: an efficient alternative to SIFT or SURF (Ethan Rublee Vincent Rabaud Kurt Konolige Gary Bradski).

The altitude acquirer 307 acquires flight altitude information concerning the altitude at which the flying body 200 is flying. The image database 302 records a plurality of lower images corresponding to different image capturing altitudes.

The flight controller 303 compares a feature point recorded in the image database 302 and a feature point extracted from an image captured during the flight, and makes the flying body 200 fly such that the feature points match.

Particularly at the time of the landing flight of the flying body 200, the flight controller 303 guides the flying body to make it land at a designated position using the image recorded in the image database 302 and the image captured during the flight.

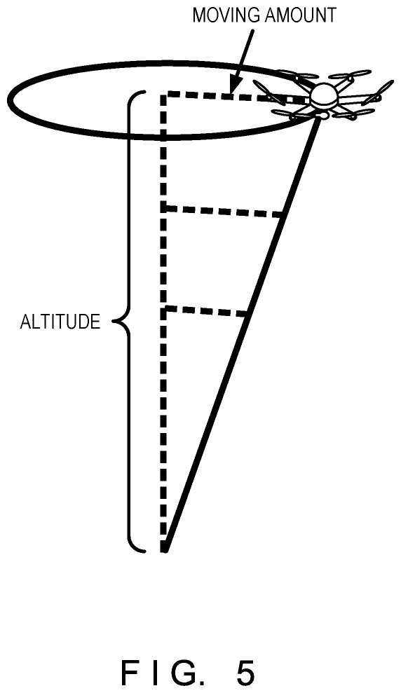

The flight controller 303 performs matching for every predetermined altitude and performs guidance in a moving amount according to the altitude any time. More specifically, a moving amount calculator 331 refers to a moving amount database 332, and derives the moving amount of the flying body 200 based the deviation between a feature point recorded in the image database 302 and a feature point extracted from a lower image captured during descent. As shown in FIG. 5, even if the number of pixels corresponding to the deviation of the same feature point does not change, the flying body needs to be moved large as the altitude becomes high. Note that an invisible geofence may virtually be set by the GPS at a position corresponding to a radius of about 5 m with respect to the landing point, and control may be performed to perform a descent at a point to hit the geofence.

The target mark 215 as shown in FIG. 2B may be added by software as a designated landing position in an image recorded in the image database 302. The flight controller 303 guides the flying body 200 to make it land at the designated landing position added to the image data 321.

The feature extractor 306 recognizes a moving body (human, automobile, bicycle, train, boat, or the like) based on its shape from the image data 321 recorded in the image database 302 in advance, and excludes the moving body from the extraction target of feature points.

When the flying body flies up to the destination and then moves to a designated landing point, the flight controller 303 makes the flying body fly to a point near the landing point using a signal from a GPS (Global Positioning System). After that, the feature point of the image designated as the landing point is read out, and the flying body is guided to the designated landing point while performing matching with the feature point extracted from an image captured during the flight.

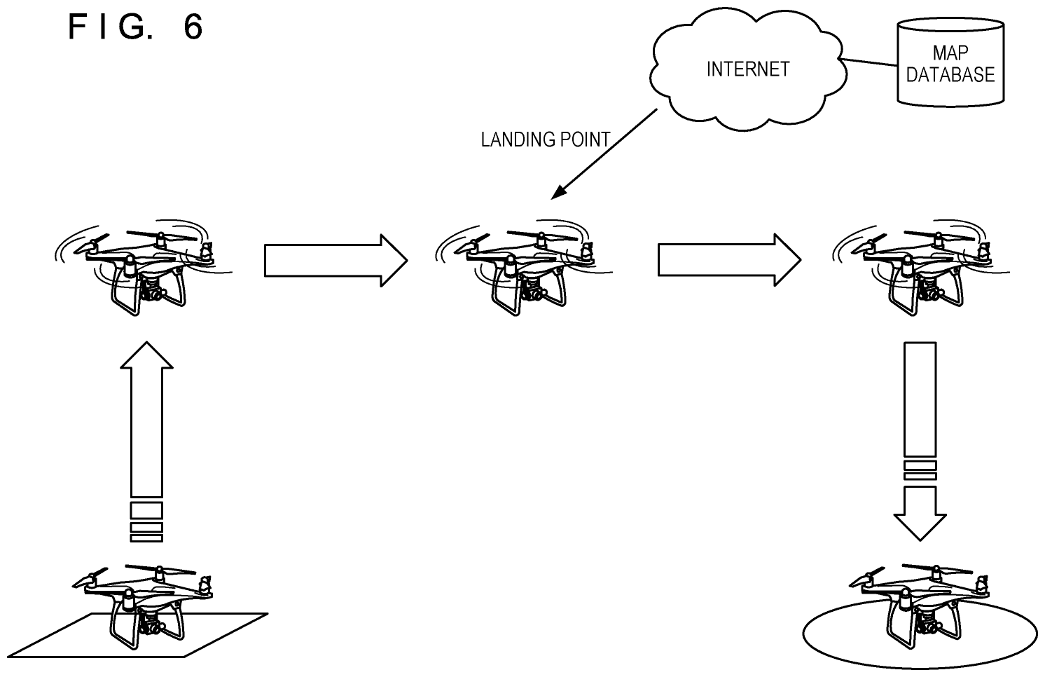

According to this arrangement, since an image captured in advance is used, as shown in FIG. 6, it is possible to freely designate the landing point after sufficiently examining it before the flight.

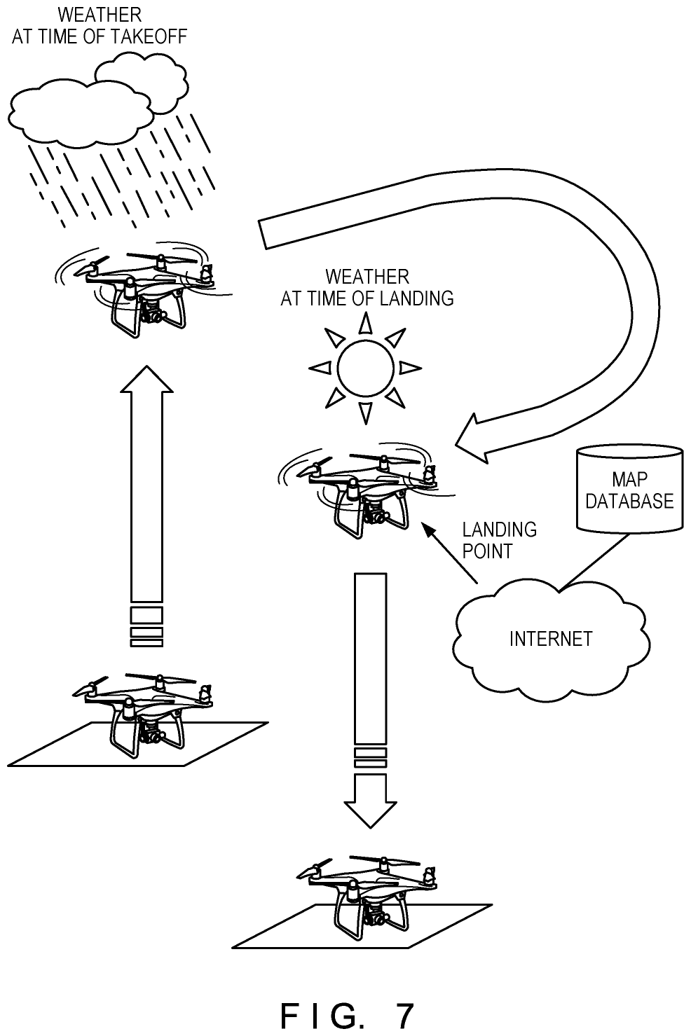

Additionally, as shown in FIG. 7, even if a condition changes from, for example, rain at the time of takeoff to a fine weather at the time of landing, an image according to the conditions (time, weather, altitude, and the like) at the time of landing can be selected from a plurality of images captured in advance and used. At this time, the image may be selected based on the characteristic of the image itself (the brightness, contrast, or color distribution of the image).

In addition, switching may be done between an image used at a point higher than a predetermined altitude and an image used at a lower point. For example, when the flying body 200 is flying at a position higher than a predetermined altitude, the guidance may be performed using a satellite image or an aerial image as a reference image. When the flying body 200 is located at a point lower than the predetermined altitude, the guidance may be performed using a marker image registered in advance as a reference image.

The reference image may be switched not based on the acquired altitude but depending on the number of feature points in a captured image.

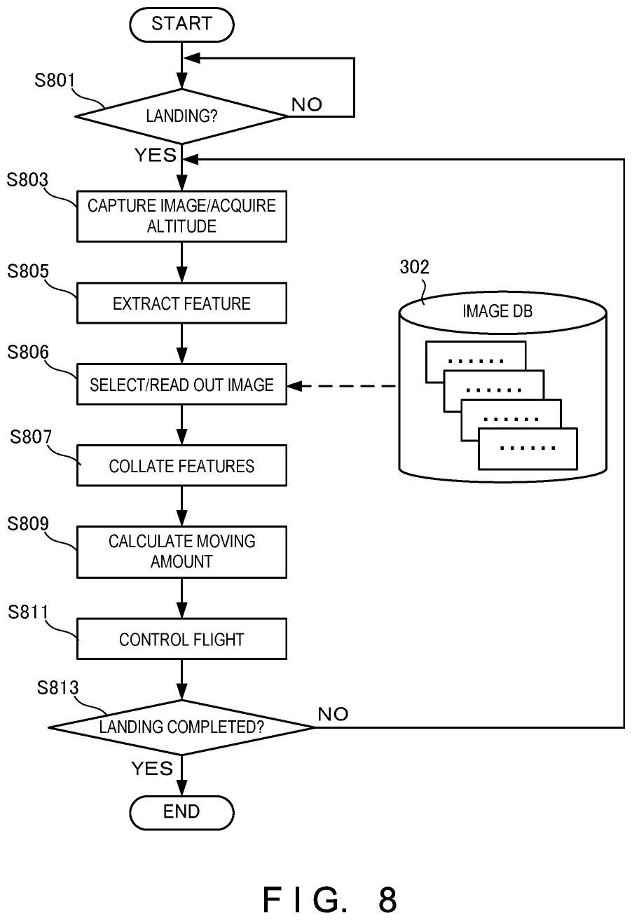

FIG. 8 is a flowchart showing the procedure of processing performed in the flying body 200 according to this example embodiment. The procedure of processing using image data in the image database 302 at the time of landing will be described here as an example. However, the present invention is not limited to the landing time, and can also be applied to hovering at a designated position or a flight on a designated route. First, in step S801, it is determined whether a landing instruction is accepted. If a landing instruction is accepted, the process advances to step S803, the image capturer 304 captures a lower image, and at the same time, the altitude acquirer 307 acquires the altitude.

In step S805, while the captured lower image is recorded in the image database 302, the feature extractor 306 extracts a feature point from the lower image. In step S806, an image that designates a landing point, which is an image (or its feature point) suitable for matching with the lower image captured in real time is selected and read out from the image database 302.

At this time, as described above, the image to be matched with the image captured during the flight is selected based on at least one of the imaging date/time, the weather at the time of image capturing, the image capturing altitude, and the brightness, contrast, and color distribution of each image. At this time, an image recorded in the image database 302 in advance may be enlarged/reduced in accordance with the flight altitude of the flying body 200. That is, if the flight altitude is higher than the image capturing altitude, the image is reduced. If the flight altitude is lower, the image is enlarged.

Next, in step S807, collation of features is performed. In step S809, the moving amount calculator 331 calculates the moving amount of the flying body 200 from the position deviation amount (the number of pixels) of the feature point. The process advances to step S811, and the flight controller 303 moves the flying body 200 in accordance with the calculated moving amount.

Finally, in step S813, it is determined whether landing is completed. If the landing is not completed, the process returns to step S803 to repeat the processing.

According to this example embodiment, it is possible to accurately make a flying body fly at a desired position. It is possible to designate a flight point such as a landing point after sufficiently examining it before the flight using an image captured in advance, and an accurate flight can be performed without any burden on the pilot.

### Third Example Embodiment

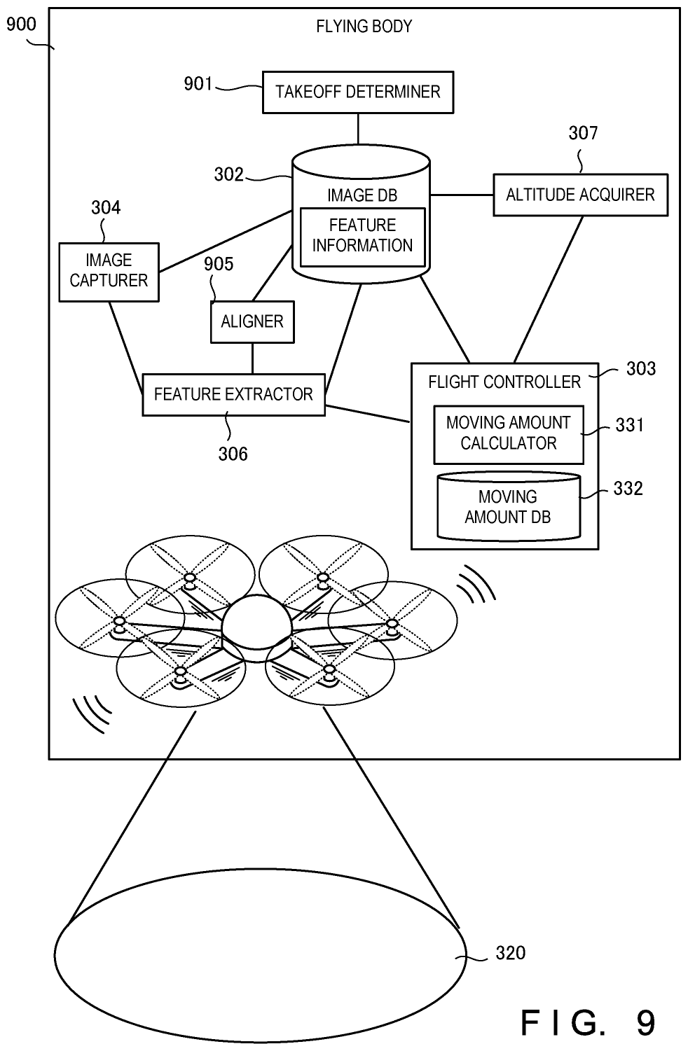

A flying body according to the third example embodiment of the present invention will be described next with reference to FIG. 9. FIG. 9 is a view for explaining the internal arrangement of a flying body 900 according to this example embodiment. The flying body 900 according to this example embodiment is different from the above-described second example embodiment in that a takeoff determiner 901 and an aligner 905 are provided. The rest of the components and operations is the same as in the second example embodiment. Hence, the same reference numerals denote similar components and operations, and a detailed description thereof will be omitted.

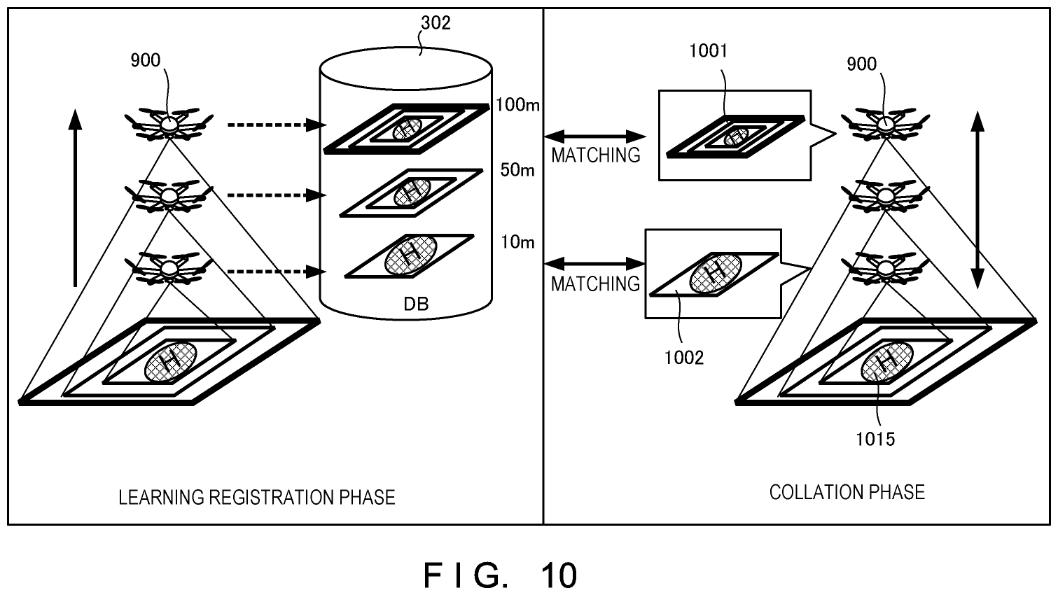

As shown in FIG. 10, if it is determined that a flying body 200 is taking off and ascending, an image database 302 shifts to a learning registration phase, causes an image capturer to capture a lower image at a predetermined altitude, and records the captured lower image. In addition, if it is determined that the flying body 200 is descending to land, a flight controller 303 shifts to a collation phase, and uses feature points that overlap between an image recorded in the image database 302 during takeoff/ascent and an image recorded in the image database 302 before the takeoff. Matching between the feature points and lower images 1001 and 1002 captured during descent is performed, and the flying body is guided to a takeoff point 1015 designated in advance while descending.

At the time of takeoff/ascent, an image capturer 304 faces directly downward and captures/learns images. At the time of horizontal movement after that, the image capturer 304 captures images in arbitrary directions. At the time of landing, the flying body 200 is returned to the neighborhood by a GPS. At the time of landing, the flying body descends while directing the image capturer 304 downward to capture images.

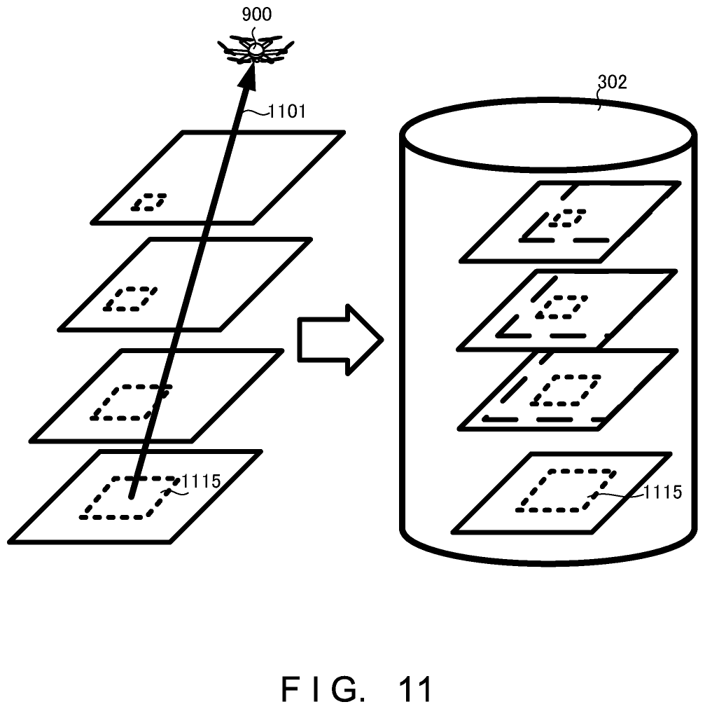

As shown in FIG. 11, the aligner 905 performs alignment of lower images to absorb a position deviation 1101 of the flying body 200 during takeoff/ascent, and then records the images in the image database 302. That is, the lower images are cut such that a takeoff point 1115 is always located at the center.

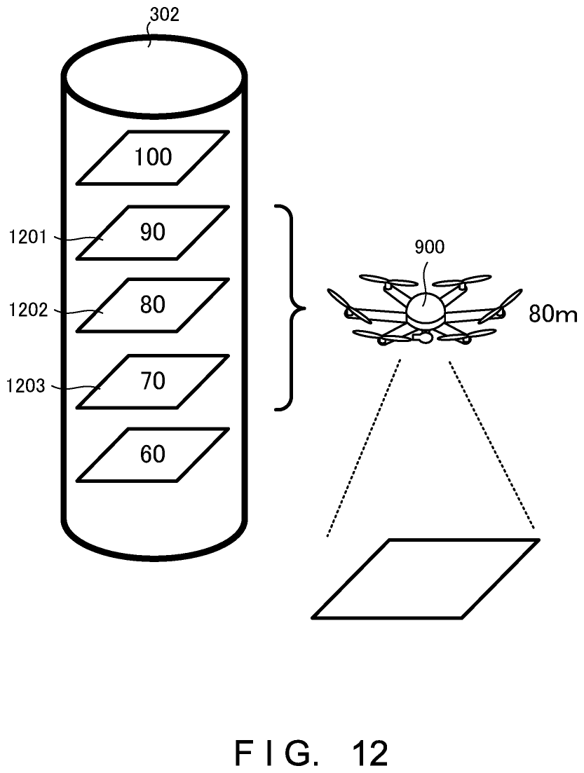

A flight controller 303 compares feature points recorded in the image database 302 with feature points extracted from lower images captured during descent. In accordance with flight altitude information, the flight controller 303 selects, from the image database 302, contents for which matching with lower images captured during descent should be performed. More specifically, as shown in FIG. 12, as images to be compared with images captured at the position of an altitude of 80 m during descent of the flying body 200, (the feature points of) three lower images 1201 to 1203 recorded in the image database 302 in correspondence with altitudes of 90 m, 80 m, and 70 m are selected.

At this time, if the altitude can be acquired from an altitude acquirer 307, the flight controller 303 selects a feature point using the altitude as reference information. If the altitude cannot be acquired, the comparison target is changed from a lower image of a late acquisition timing to a lower image of an early acquisition timing.

As described above, in this example embodiment, a feature point included in both a lower image captured by the image capturer during takeoff/ascent of the flying body and an image captured before the flying body starts the flight is compared with a feature point extracted from an image captured during the flight. A feature point included in only one of the images is excluded. Since feature points that overlap between feature points acquired in the past and feature points acquired at the time of ascent are used, noise such as a moving body can be excluded.

### Fourth Example Embodiment

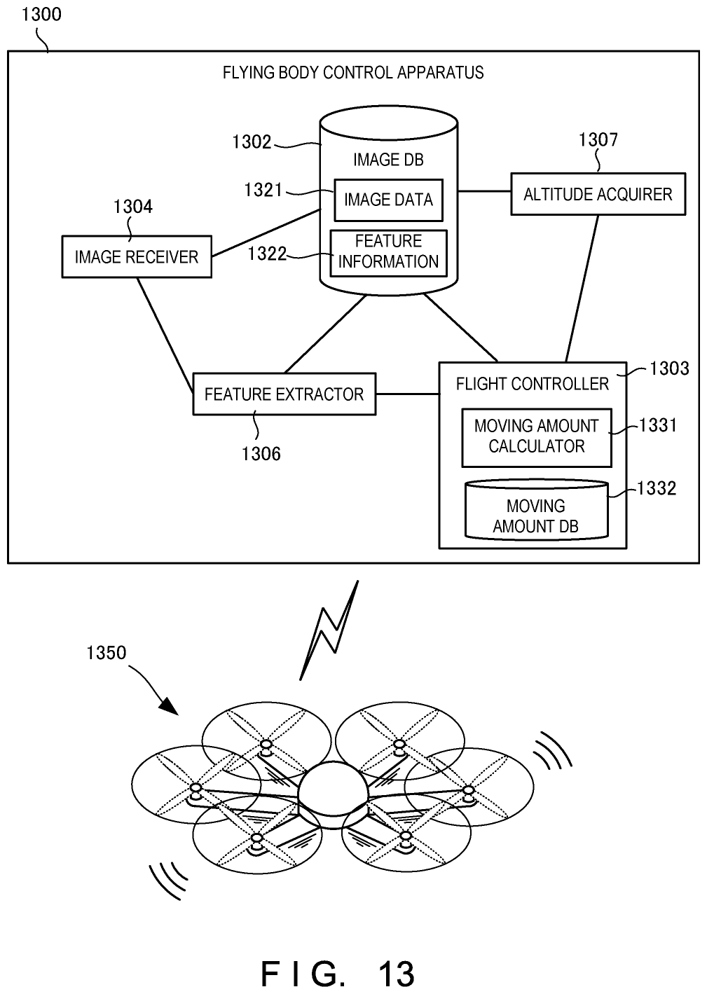

A flying body control apparatus 1300 according to the fourth example embodiment of the present invention will be described next with reference to FIG. 13. FIG. 13 is a view for explaining the internal arrangement of the flying body control apparatus 1300 (so-called transmitter for radio-controlled toys) according to this example embodiment.

The flying body control apparatus 1300 according to this example embodiment includes an image database 1302, a flight controller 1303, an image receiver 1304, a feature extractor 1306, and an altitude acquirer 1307.

The image receiver 1304 receives an image captured by a flying body 1350.

The image database 1302 records image data 1321 of a landscape image captured before the flying body 1350 starts a flight.

The image capturer 1304 captures the periphery of the flying body 1350, and records the acquired image data in the image database 1302.

The flight controller 1303 controls the flight of the flying body 1350 using the landscape image recorded in the image database 1302 and a landscape image received by the image receiver 1304 during the flight.

The image data 1321 recorded in the image database 1302 may be a landscape image accessibly saved on the Internet. For example, it may be the image data of a landscape image generated by a satellite photograph or an aerial photograph, or may be the image data of a landscape image captured in advance by another flying body.

The feature extractor 1306 extracts a feature point from the image data recorded in the image database 1302. The image database 1302 records feature information 1322 extracted from the image data 1321 in association with the image data 1321. A technique of extracting feature information from an image for matching is disclosed in ORB: an efficient alternative to SIFT or SURF (Ethan Rublee Vincent Rabaud Kurt Konolige Gary Bradski).

The altitude acquirer 1307 acquires flight altitude information concerning the altitude at which the flying body 1350 is flying. The image database 1302 records a plurality of lower images corresponding to different image capturing altitudes.

The flight controller 1303 compares a feature point recorded in the image database 1302 and a feature point extracted from an image captured during the flight, and makes the flying body 1350 fly such that the feature points match.

According to this example embodiment, the flying body can accurately be landed at a desired point.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims. A system or apparatus including any combination of the individual features included in the respective example embodiments may be incorporated in the scope of the present invention.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

### Other Expressions of Example Embodiments

Some or all of the above-described embodiments can also be described as in the following supplementary notes but are not limited to the followings.

(Supplementary Note 1)

There is provided a flying body comprising:

an image capturer that captures a periphery of the flying body;

a recorder that records an image captured before the flying body starts a flight; and

a flight controller that makes the flying body fly to a designated position using the image recorded in the recorder and an image captured during the flight.

(Supplementary Note 2)

There is provided the flying body according to supplementary note 1, wherein the image recorded in the recorder is a landscape image accessibly saved on the Internet.

(Supplementary Note 3)

There is provided the flying body according to supplementary note 1, wherein the image recorded in the recorder is a landscape image captured in advance by another flying body.

(Supplementary Note 4)

There is provided the flying body according to any one of supplementary notes 1 to 3, wherein the flight controller selects an image to be used during the flight from images recorded in the recorder based on at least one of a flight time, a weather at the time of the flight, and a flight altitude.

(Supplementary Note 5)

There is provided the flying body according to any one of supplementary notes 1 to 4, wherein the flight controller selects the image to be used during the flight from the images recorded in the recorder based on at least one of a brightness of the image, a contrast of the image, and a color distribution of the image.

(Supplementary Note 6)

There is provided the flying body according to any one of supplementary notes 1 to 5, wherein

the recorder further records a feature point extracted from the image, and

the flight controller compares the feature point recorded in the recorder and a feature point extracted from the image captured during the flight, and makes the flying body fly such that the feature points match.

(Supplementary Note 7)

There is provided the flying body according to supplementary note 6, wherein a feature point included in both a lower image captured by the image capturer during takeoff/ascent of the flying body and an image captured before the flying body starts the flight is compared with the feature point extracted from the image captured during the flight.

(Supplementary Note 8)

There is provided the flying body according to any one of supplementary notes 1 to 7, wherein at the time of a landing flight, the flight controller makes the flying body land at the designated position using the image recorded in the recorder and the image captured during the flight.

(Supplementary Note 9)

There is provided the flying body according to supplementary note 8, wherein a landing position is designated in the image recorded in the recorder, and the flight controller makes the flying body land at the designated landing position.

(Supplementary Note 10)

There is provided the flying body according to any one of supplementary notes 1 to 9, wherein a moving body is recognized from the image recorded in the recorder in advance and excluded.

(Supplementary Note 11)

There is provided a flying body control apparatus comprising:

an image receiver that receives an image acquired by capturing a periphery of a flying body;

a recorder that records an image captured before the flying body starts a flight; and

a flight controller that makes the flying body fly to a designated position using the image recorded in the recorder and an image captured during the flight.

(Supplementary Note 12)

There is provided a control method of a flying body, comprising:

capturing a periphery of the flying body; and

making the flying body fly to a designated position using an image captured before the flying body starts a flight and recorded in a recorder and an image captured during the flight in the capturing.

(Supplementary Note 13)

There is provided a flying body control program for causing a computer to execute a method, comprising:

capturing a periphery of the flying body; and

making the flying body fly to a designated position using an image captured before the flying body starts a flight and recorded in a recorder and an image captured during the flight in the capturing.

1. A flying body comprising:
an image capturer that captures a periphery of the flying body;
a recorder that records an image captured before the flying body starts a flight; and
a flight controller that makes the flying body fly to a designated position using the image recorded in the recorder and an image captured during the flight.

2. The flying body according to claim 1, wherein the image recorded in the recorder is a landscape image accessibly saved on the Internet.

3. The flying body according to claim 1, wherein the image recorded in the recorder is a landscape image captured in advance by another flying body.

4. The flying body according to claim 1, wherein the flight controller selects an image to be used during the flight from images recorded in the recorder based on at least one of a flight time, a weather at the time of the flight, and a flight altitude.

5. The flying body according to claim 1, wherein the flight controller selects the image to be used during the flight from the images recorded in the recorder based on at least one of a brightness of the image, a contrast of the image, and a color distribution of the image.

6. The flying body according to claim 1, wherein
the recorder further records a feature point extracted from the image, and
the flight controller compares the feature point recorded in the recorder and a feature point extracted from the image captured during the flight, and makes the flying body fly such that the feature points match.

7. The flying body according to claim 6, wherein a feature point included in both a lower image captured by the image capturer during takeoff/ascent of the flying body and an image captured before the flying body starts the flight is compared with the feature point extracted from the image captured during the flight.

8. The flying body according to claim 1, wherein at the time of a landing flight, the flight controller makes the flying body land at the designated position using the image recorded in the recorder and the image captured during the flight.

9. The flying body according to claim 8, wherein a landing position is designated in the image recorded in the recorder, and the flight controller makes the flying body land at the designated landing position.

10. The flying body according to claim 1, wherein a moving body is recognized from the image recorded in the recorder in advance and excluded.

11. A flying body control apparatus comprising:
an image receiver that receives an image acquired by capturing a periphery of a flying body;
a recorder that records an image captured before the flying body starts a flight; and
a flight controller that makes the flying body fly to a designated position using the image recorded in the recorder and an image captured during the flight.

12. A control method of a flying body, comprising:
capturing a periphery of the flying body; and
making the flying body fly to a designated position using an image captured before the flying body starts a flight and recorded in a recorder and an image captured during the flight in the capturing.

13. A non-transitory computer readable medium storing a flying body control program for causing a computer to execute a method, comprising:
capturing a periphery of the flying body; and
making the flying body fly to a designated position using an image captured before the flying body starts a flight and recorded in a recorder and an image captured during the flight in the capturing.
